(19) United States
(12) Patent Application Publication
(10) Pub. No.: US 2018/0143970 A1
(43) Pub. Date: May 24, 2018

(54) CONTEXTUAL DICTIONARY FOR TRANSCRIPTION

(71) Applicant: Microsoft Technology Licensing, LLC, Redmond, WA (US)

(72) Inventors: Evgeny Skarbovsky, Sammamish, WA (US); Frank Tompkins Spokane, Washington, DC (US); Gregory Paul Baribault, Sammamish, WA (US)

(73) Assignee: Microsoft Technology Licensing, LLC, Redmond, WA (US)

(21) Appl. No.: 15/356,165

(22) Filed: Nov. 18, 2016

(51) Int. Cl. G06F 17/27; G10L 15/18

(52) U.S. Cl. CPC G06F 17/2735; G10L 15/1822; G10L 2015/088; G06F 17/2795; G10L 15/1815

(57) ABSTRACT

The functionality of devices used to transcribe events is augmented with a contextual dictionary for the event to be transcribed. Contextual information for the event are discovered, which are used to customize the dictionary to the event and to locate supplemental contextual information in a graph database to further customize the event. Supplemental contextual information include the parsed names and vocabulary items discovered in the one or more data sources for entities related to those discovered in a graph database are being related to the contextual information according to one or more graph queries. The supplemental context information provides terminology and names that may be spoken during the event, but otherwise would have been omitted from affecting the contextualized dictionary according to the contextual information.

### BACKGROUND

A meeting, webinar, or other online or broadcast event may be transcribed to text and presented as captions to an audience. The transcription that results may be made available for download following the event. When the text captions are machine generated, as through a speech-to-text engine, mistakes are inevitable. Such mistakes make understanding the text more difficult, and distract from the viewing experience.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

To improve the quality of transcripts produced for an event, the context for the event is discovered and provided to a dictionary building engine to produce a contextual dictionary customized for transcribing that event. The context is discovered from various electronic documents related to the event and its participants to provide various terms, phrases, names, and acronyms relevant to the event for use in a contextual dictionary that would not be found in a standard transcription dictionary or to influence the confidence in given terms from the transcription dictionary. In addition to contextual information found in files associated with the meeting event (e.g., a calendar item, email, or attachment) and listed participants of the event, supplemental contextual information is retrieved according to a graph database to locate terms, phrases, names, and acronyms used by connected persons and events that are not directly involved in the event being transcribed to further affect the suggestion of terms for transcribing the event.

Through implementation of this disclosure, the functionalities of the computing devices that are employed in captioning are improved. For example, the speech-to-text algorithm may be improved and made more efficient through terminology discovery prior to the event based on contextual information and supplemental contextual information. By providing a contextual dictionary for the speech to text engine, a more reliable transcript is provided, and fewer computing resources need to be devoted to correcting the transcript.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 illustrates an example operating environment in which the construction and use of a dictionary based on context for an event may be practiced;

FIGS. 2A and 2B illustrate example user interfaces to display and interact with event-based terminology augmenting a contextual dictionary;

FIG. 3 is a flow chart showing general stages involved in an example method for constructing and providing a contextual dictionary for transcribing an event;

FIG. 4 is a block diagram illustrating example physical components of a computing device;

FIGS. 5A and 5B are block diagrams of a mobile computing device; and

FIG. 6 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

To improve the quality of transcripts produced for an event, the context for the event is discovered and provided to a dictionary building engine to produce a contextual dictionary customized for transcribing that event. The context is discovered from various electronic documents related to the event and its participants to provide various terms, phrases, names, and acronyms relevant to the event for use in a contextual dictionary that would not be found in a standard transcription dictionary or to influence the confidence in given terms from the transcription dictionary. In addition to contextual information found in files associated with the meeting event (e.g., a calendar item, email, or attachment) and listed participants of the event, supplemental contextual information is retrieved according to a graph database to locate terms, phrases, names, and acronyms used by connected persons and events that are not directly involved in the event being transcribed to further affect the suggestion of terms for transcribing the event.

Through implementation of this disclosure, the functionalities of the computing devices that are employed in captioning are improved. For example, the speech-to-text algorithm may be improved and made more efficient through terminology discovery prior to the event based on contextual information and supplemental contextual information. By providing a contextual dictionary for the speech to text engine, a more reliable transcript is provided, and fewer computing resources need to be devoted to correcting the transcript.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

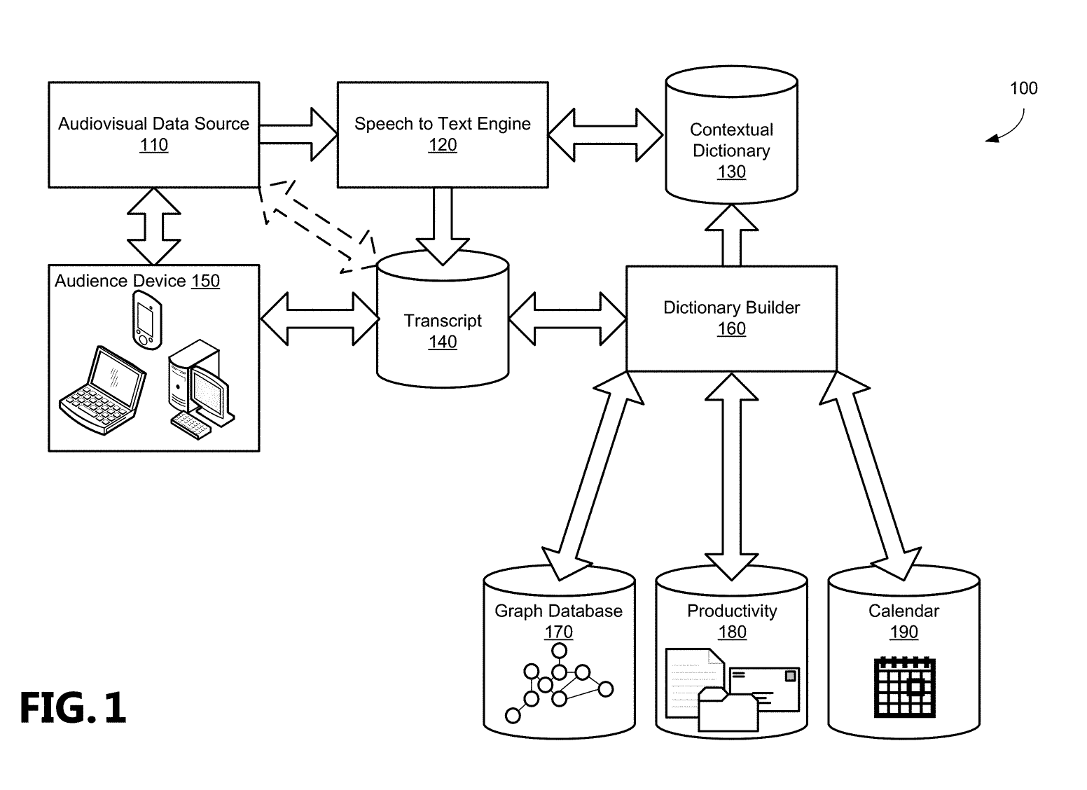

FIG. 1 illustrates an example operating environment 100 in which the construction and use of a dictionary based on context for an event may be practiced. As illustrated, an audiovisual data source communicates audiovisual data to a speech to text engine 120 and to audience devices 150. The speech to text engine 120 coverts speech data in the audiovisual data into text with the aid of a contextual dictionary 130, defining various words into which phonemes are to be translated, and stores the text of those words in a transcript database 140. The transcript database 140 provides the text as captioning data for consumption by the audience devices 150 (and optionally the audiovisual data source 110) in association with the audiovisual data, and to a dictionary builder 160, to update and refine the contextual dictionary. The dictionary builder 160 provides or adjusts the weights of terms provided in the contextual dictionary 130 and adds new terms into the contextual dictionary 130 based on primary and supplemental contextual data discovered for the event. Primary contextual data includes the parsed names and vocabulary from documents associated with the event in a productivity database 180 or calendar service 190. Supplemental contextual data includes the parsed names and vocabulary discovered in the productivity database 180 or calendar service 190 for entities related to those discovered as primary contextual data according to a graph database 170.

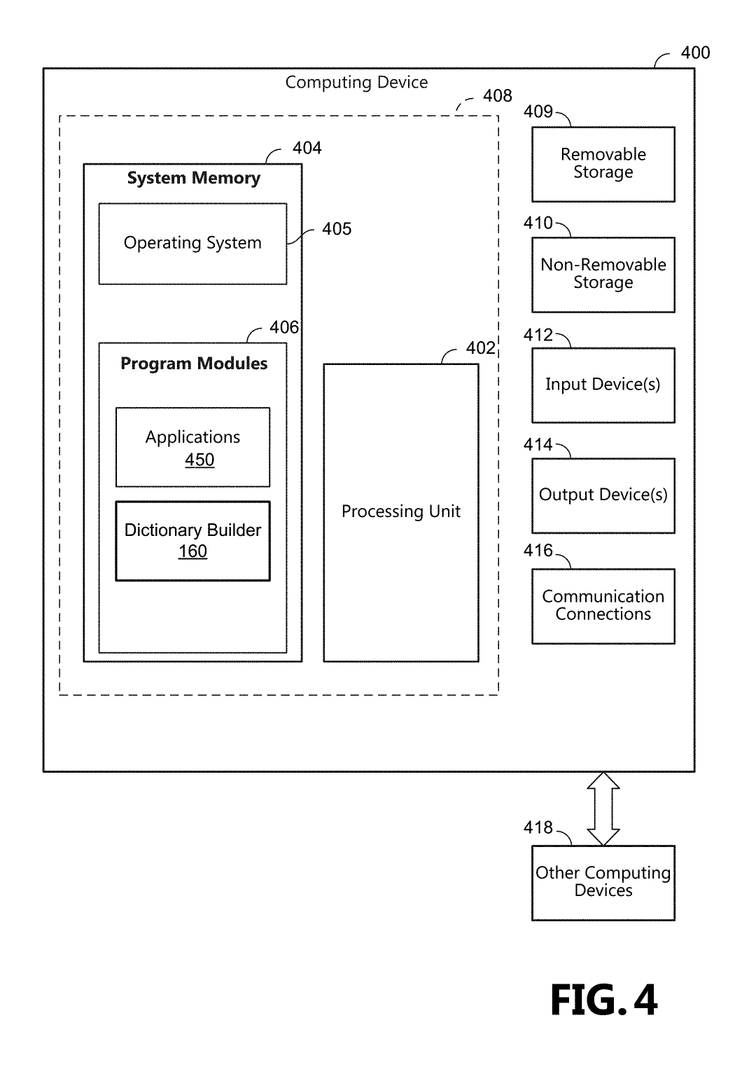

The audiovisual data source 110, speech to text engine 120, contextual dictionary 130, transcript database 140, audience devices 150, dictionary builder 160, graph database 170, productivity database 180, and calendar service 190 are illustrative of a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, printers, and mainframe computers. The hardware of these computing systems is discussed in greater detail in regard to FIGS. 4-6.

While audiovisual data source 110, speech to text engine 120, contextual dictionary 130, transcript database 140, audience devices 150, dictionary builder 160, graph database 170, productivity database 180, and calendar service 190 are shown remotely from one another for illustrative purposes, it should be noted that several configurations of one or more of these devices hosted locally to another illustrated device are possible, and each illustrated device may represent multiple instances of that device (e.g., the audience device 150 represents all of the devices used by the audience of the audiovisual data). Various servers and intermediaries familiar to those of ordinary skill in the art may lie between the component systems illustrated in FIG. 1 to route the communications between those systems, which are not illustrated so as not to distract from the novel aspects of the present disclosure.

The audiovisual data source 110 is the source for audiovisual data, which includes audiovisual data that is “live” or pre-recorded and broadcast to several audience devices 150 or unicast to a single audience device 150. In several aspects, “live” broadcasts include a transmission delay. For example, a television program that is filmed “live” is accompanied by a delay of n seconds before being transmitted from the audiovisual data source 110 to audience devices 150 to allow for image and sound processing, censorship, the insertion of commercials, etc. The audiovisual data source 110 in various aspects includes content recorders (e.g., cameras, microphones), content formatters, and content transmitters (e.g., antennas, multiplexers). In various aspects, the audiovisual data source 110 is also an audience device 150, such as, for example, when two users are connected on a teleconference by their devices, each device is an audiovisual data source 110 and an audience device 150.

Audiovisual data provided by the audiovisual data source 110 include data formatted as fixed files as well as streaming formats that include one or more sound tracks (e.g., Secondary Audio Programming (SAP)) and optionally include video tracks. The data may be split across several channels (e.g., left audio, right audio, video layers) depending on the format used to transmit the audiovisual data. In various aspects, the audiovisual data source 110 includes, but is not limited to: terrestrial, cable, and satellite television stations and on-demand program providers; terrestrial, satellite, and Internet radio stations; Internet video services, such as, for example, YOUTUBE® or VIMEO® (respectively offered by Alphabet, Inc. of Mountain View, Calif. and InterActiveCorp of New York, N.Y.); Voice Over Internet Protocol (VOIP) and teleconferencing applications, such as, for example, WEBEX® or GOTOMEETING® (respectively offered by Cisco Systems, Inc. of San Jose, Calif. and Citrix Systems, Inc. of Fort Lauderdale, Fla.); and audio/video storage sources networked or stored locally to an audience device 150 (e.g., a “my videos” folder).

The speech to text engine 120 is an automated system that receives audiovisual data and creates text, timed to the audio portion of the audiovisual data to create a transcript that may be played back in association with the audiovisual data as captions. In various aspects, the speech to text engine 120 provides data processing services based on heuristic models and artificial intelligence (e.g., machine or reinforcement learning algorithms) to extract speech from other audio data in the audiovisual data. For example, when two persons are talking over background noise (e.g., traffic, a song playing in the background, ambient noise), the speech to text engine 120 is operable to provide conversion for the speech, but not the background noises, by using various frequency filters, noise level filters, or channel filters on the audio data to isolate the speech data.

The contextual dictionary 130 provides a list of words and the phonemes from which those words are comprised to the speech to text engine 120 to match to the speech data of the audiovisual data. Although examples are given herein primarily in the English language, speech to text engines 120 and dictionaries 130 are provided in various aspects for other languages, and a user may specify one or more languages to use in creating the transcript by specifying an associated speech to text engines 120 and dictionary 130. Non-English language examples given herein will be presented using Latin text, and as appropriate in the native writing system in parenthesis afterwards, and translations (where appropriate) will be identified with guillemets (i.e., the symbols “«” and “»”). Phonemes may also be discussed in symbols associated with the International Phonetic Alphabet for English, which will be identified with square brackets (i.e., the symbols “[” and “]”) around the examples in the present disclosure to distinguish IPA examples from standard written English examples.

For words with identical or similar phonemes, such as homophones, the contextual dictionary 130 will provide multiple potential words that the speech to text engine 120 is operable to select from, based on syntax and context of the data it is translating. The speech to text engine 120 will select the entry for which it has the highest confidence in matching the identified phonemes from the contextual dictionary 130 to provide in the transcript. The speech to text engine 120 is further configured in some aspects to provide the next n-best alternatives to the best entry as suggested replacements to users; those entries with the next-most highest confidences as matching the phonemes.

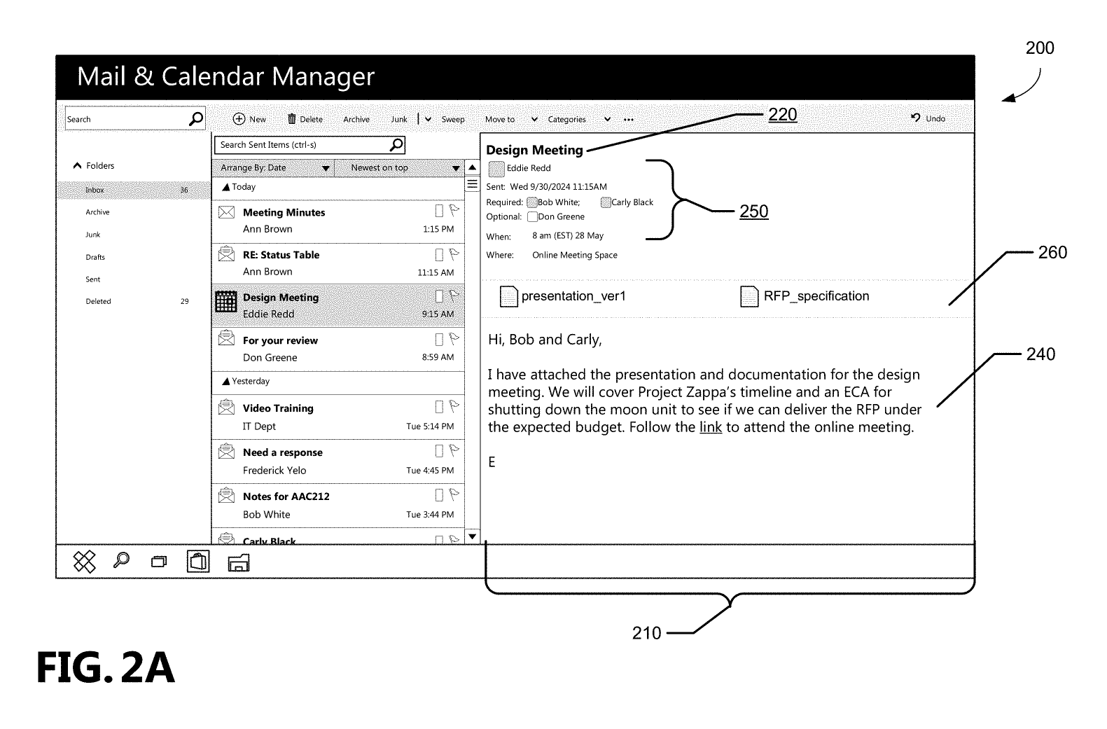

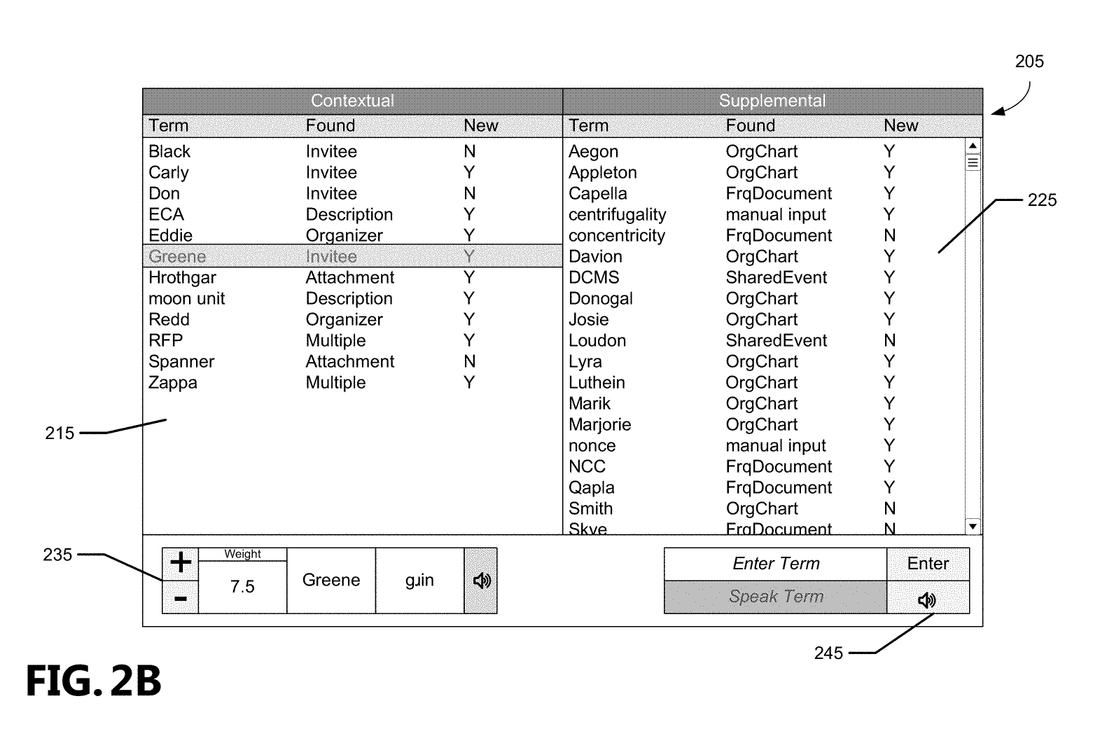

The contextual dictionary 130 is augmented from a base state (e.g., a standard dictionary, a prior-created contextual dictionary 130) to include terminology discovered via context mining from the event to be transcribed. For example, a meeting event may be mined to discover its attendees, a title and description, and documents attached to that meeting event. These data are parsed to derive contextual information about the event, and are used as a starting point to mine for additional data according to a relational graph 170 in communication with one or more databases and files repositories. Continuing the example, the names of the attendees and terms parsed from the title description and attached documents are added to the contextual dictionary 130, and are used to discover additional, supplemental contextual information for inclusion in the contextual dictionary 130. In some aspects, a user interface is provided to alert a user to the terminology affected in the contextual dictionary 130 by the discovered contextual information and supplemental information, as well as to manually personalize terminology in the contextual dictionary 130 by adding terms or influencing weightings of those terms in the contextual dictionary 130. Example user interfaces are discussed in regard to FIGS. 2A and 2B.

In various aspects, weightings or personalizations are made to the contextual dictionary 130 as feedback is received on the textual data provided in the transcript so that the choices made by the speech to text engine 120 are influenced by the feedback. For example, if the speakers in the audio data speak with an accent, the speech to text engine 120 may select incorrect words from the contextual dictionary 130 based on the unfamiliar phonemes used to pronounce the accented word. As pronunciation feedback is received to select corrected text, the word associated with the corrected text will have its confidence score in the contextual dictionary 130 increased so that the given word will be provided to the speech to text engine 120 (even if it were not before) when the phonemes are encountered again. In various aspects, pronunciation feedback specifies one of a selection of accents known for a given language or characteristics of an accent (e.g., elongated/shortened vowels, rhotic/non-rhotic, t-glottalization, flapping, consonant switches, vowel switches).

Confidence scores for a word (or words) for a given set of phonemes are influenced by an exactness of the recognized phonemes from the speech data matching stored phonemes associated with the word in the contextual dictionary 130, but also include personalization for pronunciation feedback, corrections to the transcript, and frequency of use for given words in a given language (i.e., how commonly a given word is expected to be used). For example, the words “the” and “thee” share the same phonemes in certain situations (i.e., a person may pronounce the two words identically), but the contextual dictionary 130 will associate a higher confidence score with “the” as it is used more frequently in modern English speech than “thee”. However, if the speaker is noted in feedback as using archaic English speech (e.g., in a reenactment or a period drama set in a time using archaic speech, quoting from an archaic document) or the word “the” is corrected to “thee”, the contextual dictionary 130 is personalized to the audiovisual content item to provide a greater relative confidence score to the word “thee” compared to “the” when converting the audiovisual content item's speech data into textual data. The contextual dictionary 130 may be applied to a single audiovisual content item or specified to be used for a subsequent audiovisual content item (e.g., the next episode in a series, a subsequent lecture) instead of a non-contextual dictionary. In various aspects, the speech to text engine 120 is configured to use the confidence scores provided by the contextual dictionary 130 along with its own scoring system, which may take into account syntax and grammar, to produce confidence scores for phoneme to word matching that account for other identified words.

The transcript database 140 stores one or more transcripts of textualized speech data received from the text to speech engine 120. The transcripts are synchronized with the audiovisual data to enable the provision of text in association with the audio used to produce that text. In various aspects, the transcripts are provided to the transcript database 140 as a stream while they are being produced by the speech to text engine 120 along with the audiovisual data to be transmitted, and may provide a complete or incomplete transcript for the audio visual data item at a given time. For example, a transcript may omit portions of the audiovisual content item to be transcribed when transcription began after the audiovisual content item began, thus leaving out the earlier portions of the content item from the transcript. In another example, an audiovisual content item may not be complete (e.g., a teleconference or other live event is ongoing), and the transcript, while up-to-date, is also not yet complete and is open to receive additional text data as additional audio data are received.

In various aspects, the transcript is provided to audience devices 150 and/or the audiovisual data source 110 for inclusion as captions to the audiovisual data. In other aspects, the transcript is provided to audience devices 150 as a text readout of the audiovisual data, regardless of whether the audience device 150 has received the audiovisual data on which the text data are based. The text data may be transmitted in band or out of band with any transmission of the audiovisual data according to broadcast standards, and may be incorporated into a stored version of the audiovisuals data or stored separately.

The audience device 150 in various aspects receives the audiovisual data and the transcript from the audiovisual data source 110 and the transcript database 140 respectively. In other aspects, the audience device 150 receives the transcript integrated into the audiovisual data received from the audiovisual data source 110. In yet other aspects, the audience device 150 receives the transcript from the transcript database 140 without receiving the audiovisual data from the audiovisual data source 110. In some aspects, the audience device 150 is in communication with the audiovisual data source 110 and the transcript database 140 to request changes in the content provided (e.g., request a transcript in a different language, request a different content item, to transmit feedback), while in other aspects, such as in a teleconference, the audience device 150 is an audiovisual data source 110 for its audiovisual data source 110 (which acts as an audience device 150 in turn).

The dictionary builder 160 is a computer service (including software and hardware aspects) configured to provide improvements to the contextual dictionary 130. In addition to finding contextual information related to the event being transcribed and its participants from productivity databases 180 and calendar services 190, the dictionary builder is in communication with a graph database 170. The graph database 170 is spanned to discover supplemental contextual information from those productivity databases 180 and calendar services 190 to expand vocabulary choices for the speech to text engine 120 with names and event-specific terminology beyond those associated with the event.

A graph database 170 provides one or more relational graphs with nodes describing entities and a set of accompanying properties of those entities, such as, for example, the names, titles, ages, addresses, etc. Each property can be considered a key/value pair—a name of the property and its value. In other examples, entities represented as nodes include documents, meetings, communication, etc., as well as edges representing relations among these entities, such as, for example, an edge between a person node and a document node representing that person's authorship, modification, or viewing of the associated document. Two persons who have interacted with the same document, as in the above example, will be connected by one “hop” via that document with the other person, as each person's node shares an edge with the document's node. The graph database 170 executes graph queries that are submitted by various users to return nodes or edges that satisfy various conditions (e.g., users within the same division of a company, the last X documents accessed by a given user). In various aspects, the graph database 170 is in communication with the productivity databases 180 and calendar services 190 to match actions to documents and track edges between nodes representing entities from the productivity databases 180 and calendar services 190.

The productivity database 180 includes one or more productivity applications and document repositories that are accessible by one or more users. In various aspects, the productivity database 180 is hosted on the audiovisual data source 110 and/or one or more audience device 150. For example, the productivity database 180 includes a locally executed authoring application (e.g., PAGES®, KEYNOTE®, or NUMBERS® offered by Apple, Inc. of Cupertino, Calif.) and remotely executed authoring applications (e.g., the GOOGLE DOCS™ suite offered by Alphabet, Inc. of Mountain View, Calif.) that are accessible via a thin client or web browser. In another example, the productivity database 180 includes a library of documents stored on the user device 110 as well as libraries stored on networked computers or as part of a document management system and remote storage locations (e.g., GOOGLE DRIVE™ offered by Alphabet, Inc. of Mountain View, Calif.). Documents stored in the productivity database 180 that may be parsed for relevant contextual information include, but are not limited to: word processor documents, spreadsheet documents, emails, presentation documents, notetaking documents, and computer aided drafting documents.

The calendar service 190 hosts calendar and appointment information for one or more users. Various appointments, meetings, and events (collectively, events) are stored in the calendar service 190 that include one or more persons as participants/hosts. Events include one or more of: participants (required or optional), attendance information, times, locations, resources, attached documents, and event information (e.g., event title and description). In various aspects, the calendar service 190 is provided in a unified email/calendar application, such as, for example, THUNDERBIRD® (offered by the Mozilla Fnd of Mountain View, Calif.) or GMAIL® (offered by Alphabet Inc. of Mountain View, Calif.), which stores events for a user of that application. In other aspects, the calendar service 190 includes a social media platform, such as, for example, FACEBOOK® (offered by Facebook, Inc. of Menlo Park, Calif.) where various events are posted that users may attend. In other aspects, the calendar service 190 is provided in a directory service, such as, for example, APACHE DIRECTORY™ or ORACLE INTERNET DIRECTORY™ (offered by the Apache Software Fnd of Forest Hill, Md. and Oracle Corp. of Redwood City, Calif. respectively). Events provided from the calendar service 190 may be added as entities in the relational graph 190, and/or the interactions embodied by the events are treated as edges between interacting parties.

Contextual information are parsed from the event to be transcribed, and unique vocabulary words may be added to the contextual dictionary 130 by the dictionary builder 160 in addition to strengthening or weakening the confidence scores for existing words in the contextual dictionary 130 for selection based on syntax and phoneme matching.

In one example, where the event to be transcribed is a webinar, a presentation deck, a meeting handout document, a presenter list, and an attendee list associated with the webinar are parsed to identify words and names for contextual information. The contextual dictionary 130 is then adjusted by the dictionary builder 160 so that names of presenters/attendees will be given greater consideration by the speech to text engine 120 when transcribing the speech data. For example, when an attendee has the name “Smith” recognized from the contextual information, when the speech to text engine 120 identifies phonemes corresponding to [smιθ], “Smith” will be selected with greater confidence relative to “smith”. Similarly, other variants or partial matches to [smιθ] (e.g., “Smyth”, “smithereens”, “smit”) are deprecated so that the relative confidence of “Smith” to match the phonemes for [smιθ] is increased.

In another example, where the event to be transcribed is a television broadcast (live, pre-recorded, or on-demand), a broadcast title and metadata (e.g., review, synopsis, source) are used to identify contextual information, such as, for example, character names, vocabulary lists, etc., which may be located on an internet database or program guide. For example, for an event of playback of a science fiction television series to be transcribed, a character named “Lor” is identified as contextual data for the event so that the speech to text engine 120 will have greater relative confidence in selecting “Lor” over “lore” when phonemes corresponding to [ [symbol] are identified in the speech data. Similarly, when the event specific term of “Berelian”—noted as having a pronunciation of [bεrεlian]—is identified as contextual data for the event, phonemes corresponding to [bεrεlian]—will be associated with the term “Berelian” when identified in the speech data for conversion to text. In various aspects, phoneme correspondence to a textual term for contextual data is determined based on orthographical rules of construction and spelling or a pronunciation guide.

The contextual information is used to discover supplemental contextual information in the graph database 170 according to one or more graph queries. The graph queries specify numbers, types, and strength of edges between nodes representing the entities discovered in the contextual information and nodes representing entities to use as supplemental contextual information. For example, when the name of an attendee is discovered as contextual information for the event to be transcribed (e.g., in an attendee list, as metadata or content in a document associated with the event), the node associated with that attendee in the graph database 170 is used as a starting point for a graph query. The nodes spanned according to the graph query, such as, for example, other persons, other events, and other documents interacted with by the attendee (a first “hop” in the graph database 170) or discovered as having been interacted with by entities discovered after the first hop (a subsequent “hop” spanning outward from an earlier “hop” in the graph database 170) to discover supplemental contextual information for the event to improve the contextual dictionary 130.

Consider the example in which an event to be transcribe is a meeting between department heads of an organization. The names of the department heads, talking points for the meeting, etc., are discovered as contextual information for the event from attendee/presenter lists, a meeting invitation, an attached presentation, etc. However, if the department heads were to discuss their subordinates by name (e.g., to discuss assigning action items), the names of the subordinates may not be present in the data searched for contextual information, and the contextual dictionary 130 may miss-weight the names of the subordinates, thus reducing the accuracy of the transcript, and requiring additional computing resources to correct the transcript. Instead, by querying the graph database 170 for persons or documents related to the department heads, even when those persons or documents are not indicated in the event, the contextual dictionary 130 can be expanded to include or reweight terms and names discovered that may be spoken during the event.

For example, graph queries specify one or more of: nodes within X hops from a starting node, nodes having a node type of Y (e.g., person, place, thing, meeting, document), with a strength of at least Z, to specify what nodes are discovered and returned to augment the contextual dictionary 130 with supplemental contextual data. To illustrate in relation to the above example of a department head meeting, graph queries may specify (but are not limited to), the n most recently accessed documents for each department head, the p persons with whom each department head emails most frequently, the m most recently accessed documents for the p persons with whom each department head emails most frequently, all of the persons who have accessed the n most recently access documents, etc.

The key values (e.g., identity information) for the nodes discovered by spanning the graph database 170 are used to discover the entities in productivity databases 180 and calendar services 190 with which the dictionary builder 160 is in communication. The names and terms from the data retrieved from the productivity databases 180 and calendar services 190 are parsed by the dictionary builder 160 and are used as supplemental contextual information to augment the contextual dictionary 130. In various aspects, supplemental contextual information are given lower weights or less effect on existing weights of entries in the contextual dictionary 130 than contextual information.

FIG. 2A illustrates a task management application interface 210 showing a meeting item 220. The meeting item 220 includes a title 230, a description 240, an invitee list 250, and two attached documents 260. The dictionary builder 160 is configured to parse the meeting item 220 and its included contents to discover contextual information about the event from which to augment the contextual dictionary 130 and expand its vocabulary to better anticipate the names and terms that will be spoken during the event. For example, names of the invitees, words in title headings from the documents or the event, words appearing above a certain frequency threshold in the contents, words appearing in the contents that are not already part of the contextual dictionary 130, etc. are discovered as contextual information about the event. These contextual information items are used to affect the contextual dictionary 130 and to discover more potential terms (e.g., supplemental contextual information) to influence the contextual dictionary, without requiring user input of these items.

FIG. 2B illustrates an example user interface 205 provided by the dictionary builder 160 to alert a user to the information discovered and added to the contextual dictionary 130 for the event, and to enable the user to make adjustments to the contextual dictionary. As illustrated in FIG. 2B, the example user interface 205 includes contextual terms 215 that were discovered from the meeting item 220 shown in FIG. 2A, as well as supplemental contextual terms 225 that were discovered based on the contextual information parsed from the meeting item and used in accord with a graph database 170 to discover related terms from various databases and file repositories. For example, the names that are part of the supplemental contextual terms 225 may be the names of persons related to the persons whose names appeared in the invitee list 250. In another example, the documents includes supplemental contextual terms 225 discovered from one or more documents that did not appear as attached documents 260, but have been interacted with by one or more invitees or the persons related to the invitees. In various aspects, the displayed contextual terms 215 and supplemental contextual terms 225 are shown with a source from which the term originated (or a category of the source) as well as an indicator as to whether the term overlaps another term in the contextual diction in terms of the phonemes used to detect the given term.

The example user interface 205 is also illustrated with weighting controls 235 for a user to adjust the impact of the discovered terms on the contextual dictionary 130. For example, a discovered term (from the contextual information or the supplemental contextual information) is assigned an initial weight that the user may adjust so that a given term will be chosen more or less frequently when the speech to text engine 120 accesses the contextual dictionary 130 to transcribe the event. For purposes of example, weighting is described on a zero-to-ten scale, but in various aspects, the weighting may be achieved with different scales. For example, if the phonetically similar terms “SBL” and “SVL” are both discovered and automatically added to the contextual dictionary 130 with initial weights of 8 and 2 respectively, the term “SBL” will be selected more often than “SVL” for use in the transcript. If, however, the user suspects that the term “SBL” will not be used in the meeting but “SVL” likely will, the weight of one or more of the terms may be adjusted via the weighting controls 235 so that “SVL” will be selected more frequently than “SBL” despite the initial weightings.

As illustrated, the selected contextual item 215 of “Greene” is shown with its weighting of “8.5” in proximity to the weighting controls 235 to adjust its value up or down. Other terms that share some or all of the phonemes or share similar phonemes that may be confused with the selected item (e.g., “SBL” and “SVL”) may also be presented with weighting controls 235 for the user to manually adjust the weightings of one or more words that share the same or similar phonemes.

The example user interface 205 is further illustrated as including a manual term entry control 245 by which the user may input terms that were not discovered as contextual information or supplemental contextual information that are to be included in the contextual dictionary 130 for the given event. In various aspects, the manual term entry control 245 accepts both textual and audio input to add words to the contextual dictionary 245. In additional aspects, the manual term entry control 245 is configured to enable the user to supply one or more phonemes for a selected term in addition to or instead of the current set of phonemes. For example, if the term “Qapla” is initially matched to the phonemes for [ka'pla [symbol] ], but the user recognizes that the pronunciation that speakers will use during the event corresponds to [qχap'la [symbol] ], the user may supply the expected pronunciation (verbally or by text) to include in addition to or instead of the original phoneme matching.

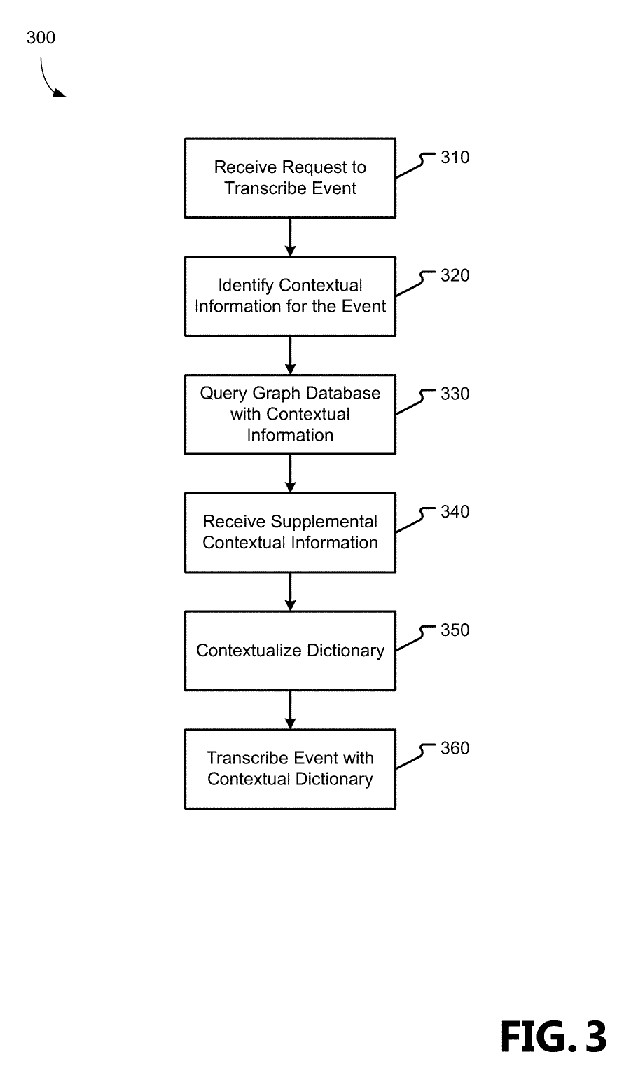

FIG. 3 is a flow chart showing general stages involved in an example method 300 for constructing and providing a contextual dictionary 130 for transcribing an event. Method 300 begins in response to receiving a request to transcribe an event at OPERATION 310. In various aspects, the request is received prior to the event starting, while in other aspects, the request is received when the transcription is to start. Events, as used herein, include, but are not limited to: meetings, webinars, live broadcasts of media, pre-recorded broadcasts of media and include both audio-only as well as audiovisual content to be transcribed.

The request, in various aspects, includes data related to the attendees (which may include or exclude the organizers), prior or future related events (e.g., is the event one of a series), a time of the event, a location of the event, a description of the event, and attached documents. At OPERATION 320, one or more of these data from the request are identified to be contextual information for the event. For example, the names of the attendees are determined to be contextual information which are to be added to (or strengthened in) the contextual dictionary 130. In other examples, a name of the event, key terms (e.g., keywords) parsed from documents associated with the event (e.g., attachments in a meeting request, hyperlinked-to web sites, cited works), and content from the description are determined to be contextual information which are to be added to (or strengthened in) the contextual dictionary 130. Key terms include acronyms (identified by parentheticals in proximity to words bearing similar starting letter), names, words found in heading formats (e.g., bolded, underlined, specified heading sections), words of non-standard spelling, words repeated at least x times in a document, words not found in an dictionary of common words, words found in proximity to keywords or triggers (e.g., the word following an honorific (Mr., Ms., Dr., Adm.) is treated as a name, the words in a format known for addresses is treated as a location name, a word preceding an abbreviation known for companies (Inc., Corp., GmBH) is treated as a company name), etc.

In various aspects, a user, such as an event organizer, may specify specific portions of the data associated with the event to be included or excluded from the determination of contextual information, and may provide additional data (e.g., transmit a new document) from that included in the request to use as contextual information. For example, based on an attendance sheet at the start of an event, the names of no-show attendees may be removed from the contextual dictionary 130 and the names of uninvited attendees who are present added to the contextual dictionary 130. In another example, an event organizer specifies particular words, terms, and associated pronunciations for inclusion in the contextual dictionary 130 via an interface to the contextual dictionary 130 or by submitting a document with those words/terms and their associated phonemes (textually or by attaching audio data).

At OPERATION 330 the contextual information discovered at OPERATION 320 are used to query a graph database 170 to discover additional supplemental contextual information for the event. In various aspects, the graph query submitted to the graph database 170 uses the contextual information as one or more starting points to span a graph comprising several nodes representing persons, documents, events, and/or groups that are linked by various edges representing interactions or relationships between the nodes. The criteria by which the graph is spanned include one or more of a number of hops between nodes (i.e., an order or relationship), a type of edge connecting nodes, a strength of the edges connecting the nodes, and a desired type of node (or property thereof).

The specified number or hops designate a maximum order of relationship between the starting node and any node returned by the query, such that, for a number of hops n, the nodes that can be linked to the starting node by n edges are spanned by the graph query. Types of edges include various types of interactions (e.g., has sent an email to, created a document, modified a document, has been shared with, co-attended an event), and relationships (e.g., are in the same office, stored in the same folder, are the same age, have the same title) for which data are stored in the graph database 170. The strengths of the edges specify various values that an edge must have to be traversed by a graph query to include a linked node, such as, for example, a document that has been accessed within the last d days, a person communicated with at least n times, the x most frequently accessed document, etc.

The type of node or a desired property from a node specify whether given nodes can be used as a hop in a chain of nodes spanning from the initial node, or as an end node from which to return supplemental context information. For example, the graph query may be forbidden from spanning nodes associated with groups, but permitted to span nodes associated with persons, documents, and events. In another example, a graph query may be permitted to only span document nodes having a property of created within the last d days. In a further example, the graph query is allowed to span any type of node, but only allowed to return nodes associated with persons having a given property (e.g., gender, age range, title).

One of ordinary skill in the art will appreciate that other values for the number of hops, types of edges, strength of edges, and types of nodes may be specified in various graph queries, and the above are given as non-limiting examples.

The nodes, or properties from those nodes, discovered in the graph database, are returned at OPERATION 340 as supplemental contextual information. The supplemental contextual information provides additional names and terms for use in the contextual dictionary 130 that are not included in the contextual information discovered from the request for transcription. In various aspects, the data from the nodes are used as the contextual information, while in other aspects, the nodes are linked to other data sources, such as, for example, a name in a directory service, a document on a file storage server, a task in an event manager, etc., which are parsed to provide terminology to contextualize a dictionary by which to transcribe the event. For example, the names of the persons associated with one or more of the attendees are identified to be supplemental contextual information which are to be added to (or strengthened in) the contextual dictionary 130. In other examples, a name of a related event, and supplemental key terms parsed from documents associated with attendees (or persons associated with the attendees) are identified to be supplemental contextual information which are to be added to (or strengthened in) the contextual dictionary 130.

The dictionary builder 160 contextualizes the dictionary at OPERATION 350. In various aspects, a standard or base dictionary is contextualized for transcribing a given event. In other aspects, an existing contextual dictionary 130 is selected for further contextualization, which may add (or remove) terminology or strengthen (or weaken) relative confidences in various terms to select as matching speech data from the event to be transcribed. For example, for an event of a quarterly earnings report presentation, a contextual dictionary 130 created for the last quarter's earnings report presentation is used, and the names of new participants are added to the existing contextual dictionary 130, and the names of persons who attended the last quarter's presentation but not the current quarter's presentation are removed from the existing contextual dictionary 130.

One or more phoneme sequences associated with terms to add to the dictionary are provided in an IPA or other phonetic representation in association with the term's spelling to configure the speech to text engine 120 to match speech data to the newly added terms. For example, the textual term “SQL” may be associated textually or audibly with one or more of [si:kw [symbol] l] or [εs:kju:εl]. In some aspects, the phoneme sequences are provided from a spoken source, discovered via a dictionary, or generated according to orthographical rules for a given langue being transcribed.

Proceeding to OPERATION 350, the event is transcribed according to the contextualized dictionary produced in accord with the contextual information and the supplemental contextual data. Speech data are recognized in the audio portions of the event, which may include audio data encoded on one or more channels, that are filtered from background audio and channels including background versus foreground audio. The speech to text engine 120 populates a transcript with textual data recognized from the contextual dictionary 130, which may be saved to a transcript database 140 and/or transmitted to audience devices 150 as captioning in concert and synchronized to the audio data from the event. Method 300 may then conclude.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 4-6 and the associated descriptions provide a discussion of a variety of operating environments in which examples are practiced. However, the devices and systems illustrated and discussed with respect to FIGS. 4-6 are for purposes of example and illustration and are not limiting of a vast number of computing device configurations that are utilized for practicing aspects, described herein.

FIG. 4 is a block diagram illustrating physical components (i.e., hardware) of a computing device 400 with which examples of the present disclosure may be practiced. In a basic configuration, the computing device 400 includes at least one processing unit 402 and a system memory 404. According to an aspect, depending on the configuration and type of computing device, the system memory 404 comprises, but is not limited to, volatile storage (e.g., random access memory), non-volatile storage (e.g., read-only memory), flash memory, or any combination of such memories. According to an aspect, the system memory 404 includes an operating system 405 and one or more program modules 406 suitable for running software applications 450. According to an aspect, the system memory 404 includes one or more of the audiovisual data source 110, the speech to text engine 120, the contextual dictionary 130, the transcript database 140, or the dictionary builder 160. The operating system 405, for example, is suitable for controlling the operation of the computing device 400. Furthermore, aspects are practiced in conjunction with a graphics library, other operating systems, or any other application program, and are not limited to any particular application or system. This basic configuration is illustrated in FIG. 4 by those components within a dashed line 408. According to an aspect, the computing device 400 has additional features or functionality. For example, according to an aspect, the computing device 400 includes additional data storage devices (removable and/or non-removable) such as, for example, magnetic disks, optical disks, or tape. Such additional storage is illustrated in FIG. 4 by a removable storage device 409 and a non-removable storage device 410.

As stated above, according to an aspect, a number of program modules and data files are stored in the system memory 404. While executing on the processing unit 402, the program modules 406 perform processes including, but not limited to, one or more of the stages of the method 400 illustrated in FIG. 4. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 4 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 400 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 400 has one or more input device(s) 412 such as a keyboard, a mouse, a pen, a sound input device, a touch input device, etc. The output device(s) 414 such as a display, speakers, a printer, etc. are also included according to an aspect. The aforementioned devices are examples and others may be used. According to an aspect, the computing device 400 includes one or more communication connections 416 allowing communications with other computing devices 418. Examples of suitable communication connections 416 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. According to an aspect, any such computer storage media is part of the computing device 400. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

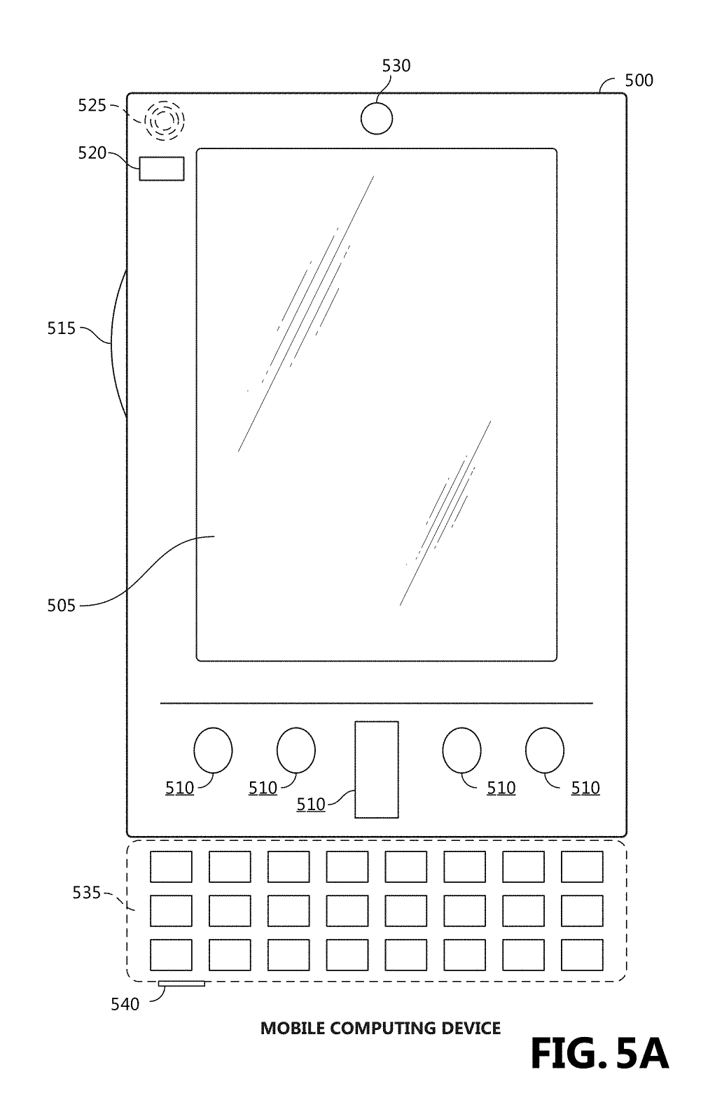

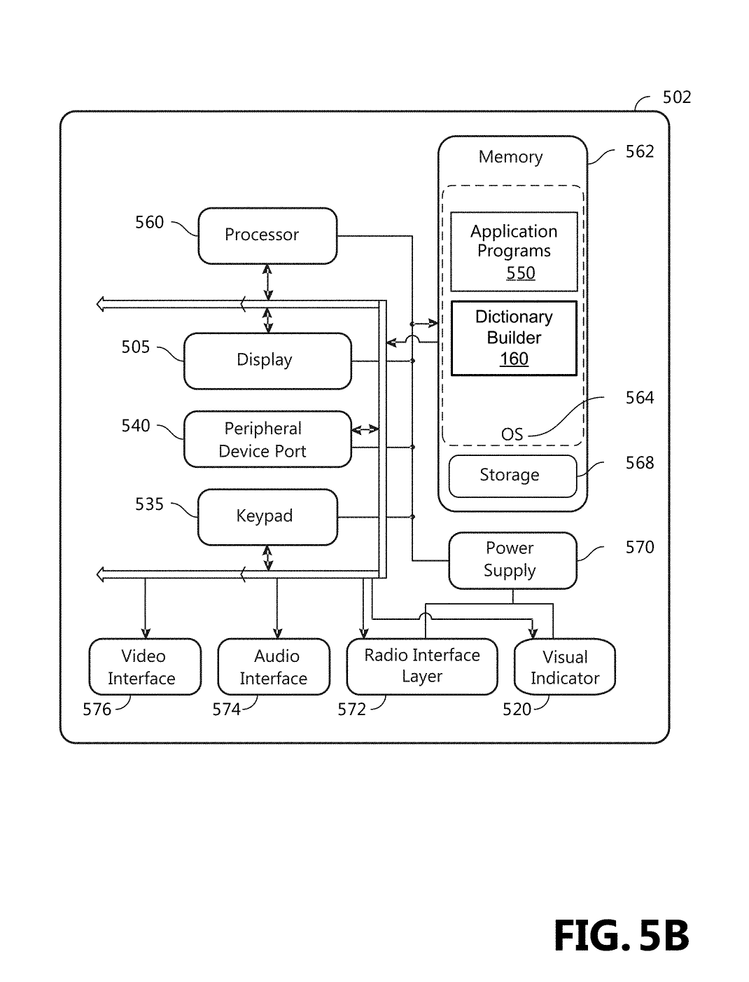

FIGS. 5A and 5B illustrate a mobile computing device 500, for example, a mobile telephone, a smart phone, a tablet personal computer, a laptop computer, and the like, with which aspects may be practiced. With reference to FIG. 5A, an example of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. According to an aspect, the display 505 of the mobile computing device 500 functions as an input device (e.g., a touch screen display). If included, an optional side input element 515 allows further user input. According to an aspect, the side input element 515 is a rotary switch, a button, or any other type of manual input element. In alternative examples, mobile computing device 500 incorporates more or fewer input elements. For example, the display 505 may not be a touch screen in some examples. In alternative examples, the mobile computing device 500 is a portable phone system, such as a cellular phone. According to an aspect, the mobile computing device 500 includes an optional keypad 535. According to an aspect, the optional keypad 535 is a physical keypad. According to another aspect, the optional keypad 535 is a “soft” keypad generated on the touch screen display. In various aspects, the output elements include the display 505 for showing a graphical user interface (GUI), a visual indicator 520 (e.g., a light emitting diode), and/or an audio transducer 525 (e.g., a speaker). In some examples, the mobile computing device 500 incorporates a vibration transducer for providing the user with tactile feedback. In yet another example, the mobile computing device 500 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 500 incorporates peripheral device port 540, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one example of a mobile computing device. That is, the mobile computing device 500 incorporates a system (i.e., an architecture) 502 to implement some examples. In one example, the system 502 is implemented as a “smart phone” capable of running one or more applications (e.g., browser, e-mail, calendaring, contact managers, messaging clients, games, and media clients/players). In some examples, the system 502 is integrated as a computing device, such as an integrated personal digital assistant (PDA) and wireless phone.

According to an aspect, one or more application programs 550 are loaded into the memory 562 and run on or in association with the operating system 564. Examples of the application programs include phone dialer programs, e-mail programs, personal information management (PIM) programs, word processing programs, spreadsheet programs, Internet browser programs, messaging programs, a dictionary builder 160, and so forth. The system 502 also includes a non-volatile storage area 568 within the memory 562. The non-volatile storage area 568 is used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

According to an aspect, the system 502 has a power supply 570, which is implemented as one or more batteries. According to an aspect, the power supply 570 further includes an external power source, such as an AC adapter or a powered docking cradle that supplements or recharges the batteries.

According to an aspect, the system 502 includes a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

According to an aspect, the visual indicator 520 is used to provide visual notifications and/or an audio interface 574 is used for producing audible notifications via the audio transducer 525. In the illustrated example, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. According to an aspect, the system 502 further includes a video interface 576 that enables an operation of an on-board camera 530 to record still images, video stream, and the like.

According to an aspect, a mobile computing device 500 implementing the system 502 has additional features or functionality. For example, the mobile computing device 500 includes additional data storage devices (removable and/or non-removable) such as, magnetic disks, optical disks, or tape. Such additional storage is illustrated in FIG. 5B by the non-volatile storage area 568.

According to an aspect, data/information generated or captured by the mobile computing device 500 and stored via the system 502 are stored locally on the mobile computing device 500, as described above. According to another aspect, the data are stored on any number of storage media that are accessible by the device via the radio 572 or via a wired connection between the mobile computing device 500 and a separate computing device associated with the mobile computing device 500, for example, a server computer in a distributed computing network, such as the Internet. As should be appreciated such data/information are accessible via the mobile computing device 500 via the radio 572 or via a distributed computing network. Similarly, according to an aspect, such data/information are readily transferred between computing devices for storage and use according to well-known data/information transfer and storage means, including electronic mail and collaborative data/information sharing systems.

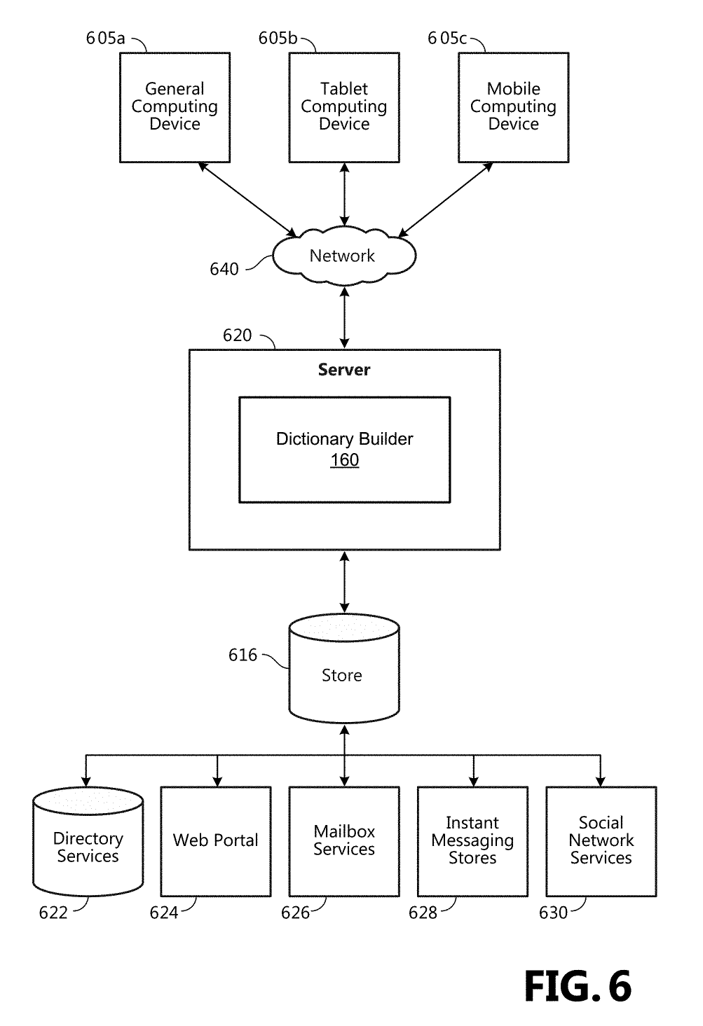

FIG. 6 illustrates one example of the architecture of a system for developing a contextual dictionary 130 as described above. Content developed, interacted with, or edited in association with the contextual dictionary 130, such as by the dictionary builder 160, is enabled to be stored in different communication channels or other storage types. For example, various documents may be stored using a directory service 622, a web portal 624, a mailbox service 626, an instant messaging store 628, or a social networking site 630. The dictionary builder 160 is configured to use any of these types of systems or the like for developing a contextual dictionary 130, as described herein. According to an aspect, a server 620 provides the dictionary builder 160 to clients 605a,b,c. As one example, the server 620 is a web server providing the dictionary builder 160 over the web. The server 620 provides the dictionary builder 160 over the web to clients 605 through a network 640 and the dictionary builder 160 may be integrated into a speech to text engine 120 or run as an independent service. By way of example, the client computing device is implemented and embodied in a personal computer 605a, a tablet computing device 605b or a mobile computing device 605c (e.g., a smart phone), or other computing device. Any of these examples of the client computing device are operable to obtain content, such as transcripts or customized contextual dictionaries 130, from the store 616.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A method, comprising:
receiving a request to transcribe an event;
identifying, from the request, contextual information for the event;
querying, using the contextual information, a graph database for supplemental contextual information;
receiving the supplemental contextual information from the graph database;
contextualizing a dictionary for the event; and
transcribing the event according to the contextualized dictionary.

2. The method of claim 1, wherein the contextual information include:
a name of an attendee of the event; and
a key term parsed from one or more of the event and documents associated with the event.

3. The method of claim 2, wherein the supplemental contextual information include:
a name of a person associated with the attendee in the graph database; and
supplemental key terms parsed from documents associated with the attendee in the graph database or associated in the graph database with the person associated with the attendee in the graph database.

4. The method of claim 3, wherein nodes representing the person associated with the attendee and the documents associated with the attendee or the person associated with the attendee in the graph database are within a specified number of hops in the graph database from a node associated with the attendee.

5. The method of claim 3, wherein nodes representing the person associated with the attendee and the documents associated with the attendee or the person associated with the attendee in the graph database are connected to a node associated with the attendee by edges of a specified strength.

6. The method of claim 3 wherein nodes representing the person associated with the attendee and the documents associated with the attendee or the person associated with the attendee in the graph database are connected to a node associated with the attendee by edges of a specified type.

7. The method of claim 1, wherein the contextual information and the supplemental contextual information add additional words to the contextualized dictionary.

8. The method of claim 1, wherein phonemes for the additional words added to the contextualized dictionary are set according to orthographic rules for a designated language.

9. The method of claim 1, wherein the contextual information and the supplemental contextual information adjust weights for preexisting words in the contextualized dictionary.

10. The method of claim 1, wherein the contextual information affects the contextualized dictionary according to a first strength and the supplemental contextual information affects the contextualized dictionary according to a second strength, wherein the second strength has less effect on the contextualized dictionary than the first strength.

11. A system, comprising:
a processor; and
a memory storage device including instructions that when executed by the processor are operable to provide a dictionary builder in communication with a graph database, a productivity database, a calendar service and a contextual dictionary, the dictionary builder configured to:
parse a transcription request to discover contextual information related to an event to transcribe;
query the graph database with the contextual information to discover nodes associated with supplemental contextual information;
locate in at least one or the productivity database and the calendar service entities associated with the nodes discovered from the graph database;
parse the entities for a keyword;
determine whether the keyword is included in the contextual dictionary;
in response to determining that the keyword is included in the contextual dictionary, increasing a confidence score for selecting the keyword during transcription; and
in response to determining that the keyword is not included in the contextual dictionary, adding the keyword to the contextual dictionary for selection during transcription.

12. The system of claim 11, wherein the contextual information include:
an attendee of the event; and
a document associated with the event.

13. The system of claim 12, wherein the supplemental contextual information include one or more of:
a person associated with the attendee in the graph database;
a document associated with the attendee in the graph database;
a document associated with the person in the graph database; and
a related event associated with the event in the graph database.

14. The system of claim 11, wherein to parse the entity for the keyword, the dictionary builder is further configured to:
identify an acronym keyword by locating a capitalized word in proximity a parenthetical and words bearing similar starting letters to letters comprising the capitalized word;
identify a heading keyword based on a heading format;
identify unique keyword based on a non-standard spelling;
identify a frequent keyword repeated a given number of times in the entity; and
identify a name keyword based on a proximity to one or more of an honorific or a company abbreviation.

15. The system of claim 11, wherein the entities include persons, documents, and events.

16. The system of claim 11, wherein the dictionary builder is further configured to locate in at least one or the productivity database and the calendar service entities associated with the contextual information.

17. A computer readable storage device, including instructions executable by a processor, comprising:
receiving a request to transcribe an event;
identifying, from the request, contextual information for the event;
querying, using the contextual information, a graph database for supplemental contextual information;
receiving the supplemental contextual information from the graph database; and
contextualizing a dictionary to produce a contextual dictionary by which to transcribe the event, wherein:
terminology and names in the contextual information and terminology and names in the supplemental contextual information that are not found in the dictionary are added to the dictionary; and
terminology and names in the contextual information and terminology and names in the supplemental contextual information that are found in the dictionary affect confidence scores of the found terminology and names.

18. The computer readable storage device of claim 17, wherein the terminology and names in the contextual information are associated with greater confidence scores than the terminology and names in the supplemental contextual information.

19. The computer readable storage device of claim 17, wherein the terminology and names added to the dictionary are associated with phonemes based on orthographical rules.

20. The computer readable storage device of claim 17, wherein the dictionary is an existing contextual dictionary for a related event.
